(19) United States
(12) Patent Application Publication
(10) Pub. No.: US 2025/0088805 A1
(43) Pub. Date: Mar. 13, 2025

(54) SPEAKERS

(71) Applicant: SHENZHEN SHOKZ CO., LTD., Shenzhen (CN)

(72) Inventors: Wenbing ZHOU, Shenzhen (CN); Lei ZHANG, Shenzhen (CN); Xin QI, Shenzhen (CN); Fengyun LIAO, Shenzhen (CN); Shanyong GU, Beijing (CN)

(73) Assignee: SHENZHEN SHOKZ CO., LTD., Shenzhen (CN)

(21) Appl. No.: 18/959,561

(22) Filed: Nov. 25, 2024

Related U.S. Application Data
(63) Continuation of application No. PCT/CN2022/142045, filed on Dec. 26, 2022.

(51) Int. Cl. H04R 7/20; H04R 1/02; H04R 7/04

(52) U.S. Cl. CPC H04R 7/20; H04R 1/025; H04R 7/04; H04R 2307/204

(57) ABSTRACT

A speaker includes a shell, a diaphragm, and a sliding connection portion. The shell includes a cavity. The diaphragm is accommodated within the cavity and separates the cavity to form at least two sub-cavities. The diaphragm is driven by an electrical signal to vibrate to generate sound. The sliding connection portion is configured to connect an edge of the diaphragm to an inner wall of the cavity. The sliding connection portion allows the edge of the diaphragm to slide relative to the inner wall of the shell. Therefore, the diaphragm can move (slide) relative to the inner wall of the shell. In other words, the diaphragm can make a piston-like movement relative to the inner wall of the shell, which allows the diaphragm to generate a greater displacement, push more air, and thereby improving the performance of the speaker, especially the sensitivity of the speaker at a low frequency range.

### CROSS-REFERENCE TO RELATED APPLICATIONS

This application is a continuation of International Patent Application No. PCT/CN2022/142045, filed on Dec. 26, 2022, the contents of which are hereby incorporated by reference.

### TECHNICAL FIELD

The present disclosure relates to the field of acoustic technology, and in particular, to a speaker.

### BACKGROUND

In a structure of an existing speaker, to avoid the front and rear cavities of the speaker from conducting, which affects a radiated sound pressure of the speaker, an edge of a diaphragm of the speaker is usually fixedly connected to a shell of the speaker. With such a structure, when the speaker is operating, the deformation of the diaphragm mainly occurs in a center region, while the deformation in a region near the fixed edge of the diaphragm is smaller. The deformation of the center region of the diaphragm is also limited by the region where the fixed edge is located, thus reducing a volume of air pushed by the diaphragm (also known as an air push volume), which has a negative impact on the performance of the speaker, in particular, impacts the low frequency performance of the speaker requiring a great displacement and a great air push volume.

Therefore, it is necessary to propose a speaker to increase the volume of air pushed by the diaphragm and enhance the low frequency performance of the speaker.

### SUMMARY

One of the embodiments of the present disclosure provides a speaker including a shell including a cavity, a diaphragm accommodated within the cavity, and a sliding connection portion. The diaphragm separates the cavity to form at least two sub-cavities. The diaphragm is driven by an electrical signal to vibrate with respect to the shell to generate sound. The sliding connection portion is configured to connect an edge of the diaphragm to an inner wall of the cavity, the sliding connection portion allowing the edge of the diaphragm to slide relative to an inner wall of the shell.

In some embodiments, the shell includes a magnet, the sliding connection portion is a magnetic fluid, a surface of the magnet forms at least a portion of the inner wall of the cavity, and the diaphragm drives the magnetic fluid to slide on the surface of the magnet.

In some embodiments, the sliding connection section includes a magnet and a magnetic fluid. The magnet is connected to the diaphragm, and the magnetic fluid is configured to connect the magnet to the inner wall of the cavity. The magnetic fluid slides with the magnet relative to the inner wall of the shell by a magnetic force between the magnetic fluid and the magnet.

In some embodiments, a carrier liquid of the magnetic fluid is an aqueous liquid or an oily liquid, a material of the inner wall of the cavity within a sliding range of the magnetic fluid is a first surface material, and a material of the inner wall of the cavity outside the sliding range of the magnetic fluid is a second surface material. A property of the carrier liquid is the same as a hydrophilic or lipophilic property of the first surface material, and the first surface material and the second surface material have opposite hydrophilic or lipophilic properties.

In some embodiments, the shell includes a first magnet, and the sliding connection portion includes a second magnet and a magnetic fluid. A surface of the first magnet forms at least a portion of the inner wall of the cavity, the second magnet is connected to the diaphragm, and the magnetic fluid is configured to connect the first magnet to the second magnet, and the diaphragm drives, through the second magnet, the magnetic fluid to slide on the surface of the first magnet.

In some embodiments, the first magnet and the second magnet are arranged with the same magnetic poles facing each other.

In some embodiments, the speaker further includes a magnetic fluid constraint structure configured to constrain a position of the magnetic fluid.

In some embodiments, the magnetic fluid constraint structure includes a first magnetic fluid constraint element and a second magnetic fluid restraint element that are disposed on the diaphragm, the first magnetic fluid restraint element and the second magnetic fluid constraint element being provided to be located on opposite sides of the magnetic fluid along a vibration direction of the diaphragm, respectively.

In some embodiments, the first magnetic fluid constraint element and the second magnetic fluid restraint element are disposed on the inner wall of the cavity and located outside the sliding range of the magnetic fluid. A distance between the first magnetic fluid constraint element and an edge of the sliding range is within a first distance threshold range, and a distance between the second magnetic fluid constraint element and the edge of the sliding range is within a second distance threshold range.

In some embodiments, the property of the carrier liquid of the magnetic fluid is the same as or opposite to the hydrophilic or lipophilic property of the surface material of the magnetic fluid constraint structure.

In some embodiments, the sliding connection portion is a fluid, wherein the material of the inner wall of the cavity within the sliding range of the fluid is a first surface material, and the material of the inner wall of the cavity outside the sliding range of the fluid is a second surface material, wherein the fluid has the same hydrophilic or lipophilic property as the first surface material, and the first surface material has opposite hydrophilic or lipophilic property as the second surface material.

In some embodiments, the fluid is a viscous fluid with a kinematic viscosity greater than 100 cst.

In some embodiments, the cavity is disposed with a concave or convex structure within a region on the inner wall of the cavity contacting the fluid.

In some embodiments, a size of the concave or convex structure on a surface of the inner wall of the cavity along a vibration direction of the diaphragm is in a range of 0.2 μm-200 μm, and a size of the concave or convex structure along a direction perpendicular to the inner wall of the cavity is in a range of 0.2 μm-200 μm.

In some embodiments, the diaphragm is a flat plate structure.

### BRIEF DESCRIPTION OF THE DRAWINGS

The present disclosure will be further illustrated by way of exemplary embodiments, which are described in detail by means of the accompanying drawings. These embodiments are not limiting, and in these embodiments, the same numbering indicates the same structure, wherein

FIG. 1 is a block diagram illustrating a structure of an exemplary speaker according to some embodiments of the present disclosure;

FIG. 2A is a schematic diagram illustrating a structure of an exemplary speaker according to some embodiments of the present disclosure;

FIG. 2B is a schematic diagram illustrating a structure of an exemplary speaker according to some other embodiments of the present disclosure;

FIG. 3 is a schematic diagram illustrating frequency response curves of a speaker with a sliding connection portion and a speaker without the sliding connection portion according to some embodiments of the present disclosure;

FIG. 4 is a schematic diagram illustrating a structure of an exemplary speaker according to some embodiments of the present disclosure;

FIG. 5A is a schematic diagram illustrating a structure of an exemplary speaker according to some embodiments of the present disclosure;

FIG. 5B is a schematic diagram illustrating a local distribution of magnetic induction lines of a magnet in FIG. 5A;

FIG. 5C is a schematic diagram illustrating the speaker shown in FIG. 5A when the diaphragm is in a position with a first maximum vibration amplitude;

FIG. 5D is a schematic diagram illustrating the speaker shown in FIG. 5A when the diaphragm is in a position with a second maximum vibration amplitude;

FIG. 6A is a schematic diagram illustrating a structure of an exemplary speaker according to some embodiments of the present disclosure;

FIG. 6B is a schematic diagram illustrating a structure of an exemplary speaker according to some other embodiments of the present disclosure;

FIG. 6C is a schematic diagram illustrating a structure of an exemplary speaker according to other embodiments of the present disclosure;

FIG. 6D is a schematic diagram illustrating a structure of an exemplary speaker according to some other embodiments of the present disclosure;

FIG. 7A is a schematic diagram illustrating a structure of an exemplary speaker according to some embodiments of the present disclosure;

FIG. 7B is a schematic diagram illustrating the speaker shown in FIG. 7A when a diaphragm is vibrating;

FIG. 8A is a schematic diagram illustrating a structure of an exemplary speaker according to some embodiments of the present disclosure;

FIG. 8B is a schematic diagram illustrating a structure of an exemplary speaker according to some other embodiments of the present disclosure;

FIG. 9A is a schematic diagram illustrating a structure of an exemplary speaker according to some embodiments of the present disclosure; and

FIG. 9B is a schematic diagram illustrating a structure of an exemplary speaker according to some other embodiments of the present disclosure.

### DETAILED DESCRIPTION

To more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for those skilled in the art to apply the present disclosure to other similar scenarios in accordance with these drawings without creative labor. Unless obviously obtained from the context or the context illustrates otherwise, the same numeral in the drawings refers to the same structure or operation.

It should be understood that as used herein, the terms “system,” “device,” “unit” and/or “module” as used herein is a way to distinguish between different components, elements, parts, sections, or assemblies at different levels. However, the words are replaced by other expressions if other words accomplish the same purpose.

As shown in the present disclosure and the claims, unless the context clearly suggests an exception, the words “a,” “an,” “one,” and/or “the” do not refer specifically to the singular, but also include the plural. Generally, the terms “including” and “comprising” suggest only the inclusion of clearly identified operations and elements. In general, the terms “including” and “comprising” only suggest the inclusion of explicitly identified operations and elements that do not constitute an exclusive list, and the method or apparatus also includes other operations or elements.

In the description of the present disclosure, it is to be understood that the terms “first,” “second,” “third,” “fourth,” etc., are used for descriptive purposes only, and are not to be understood as indicating or implying relative importance or implicitly specifying the number of technical features indicated. Thereby, the limitations “first,” “second,” “third,” and “fourth” expressly or implicitly include at least one such feature. In the description of the present disclosure, “plurality” means at least two, e.g., two, three, etc., unless otherwise expressly and specifically limited.

In the present disclosure, unless otherwise expressly specified or limited, the terms “connection,” “fixing,” etc. shall be broadly construed. For example, the term “connection” refers to a fixed connection, a removable connection, or an integrated connection; a mechanical connection, or an electrical connection; a direct connection, or an indirect connection through an intermediate medium, a connection within two elements, or an interaction between two elements, unless expressly limited otherwise. To those skilled in the art, the specific meaning of the above terms in the present disclosure is understood on a case-by-case basis.

The present disclosure provides a speaker including a shell, a diaphragm, and a sliding connection portion. The shell includes a cavity. The diaphragm is accommodated within the cavity, which separates the cavity to form at least two sub-cavities. The diaphragm is driven by an electrical signal to vibrate relative to the shell to generate sound. The sliding connection portion is configured to connect an edge of the diaphragm to an inner wall of the cavity. The sliding connection portion allows the edge of the diaphragm to slide relative to the inner wall of the shell, so that the diaphragm as a whole is able to displace relative to the inner wall of the shell. In other words, the diaphragm as a whole makes a piston-like movement relative to the inner wall of the shell, which allows the diaphragm to generate a greater displacement, push more air, and thereby improving the performance of the speaker, especially the sensitivity of the speaker at a low frequency range.

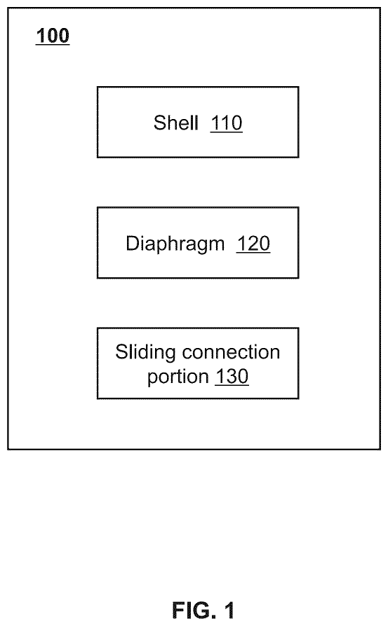

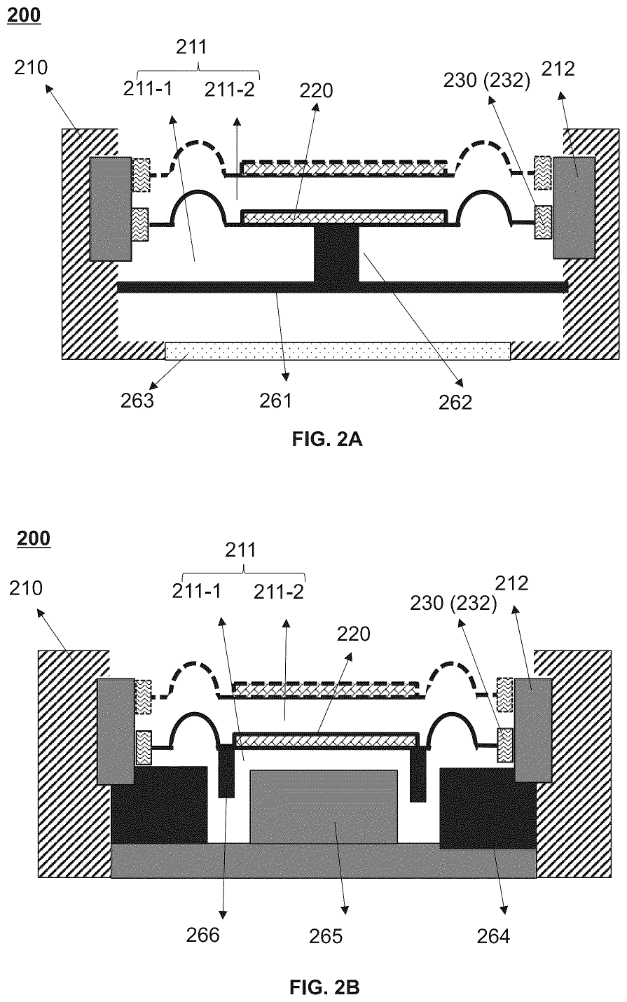

FIG. 1 is a block diagram illustrating a structure of an exemplary speaker according to some embodiments of the present disclosure. In some embodiments, a speaker 100 includes a piezoelectric speaker (as shown in FIG. 2A), an electromagnetic speaker (as shown in FIG. 2B), a moving iron speaker, an electrostatic speaker, etc., or any combination thereof. As shown in FIG. 1, the speaker 100 includes a shell 110, a diaphragm 120, and a sliding connection portion 130.

The shell 110 is configured to carry other components of the speaker 100 (e.g., the diaphragm 120, the sliding connection portion 130, etc.). The shell 110 has a cavity. One or more components of the speaker 100 are disposed within the cavity. In some embodiments, the shell 110 is a regular or irregular three-dimensional (3D) structure such as a cuboid, a cylinder, etc. When the user wears the speaker 100, the shell 110 is located near a user's ear. For example, the shell 110 is located on a circumferential side (e.g., a front side or a rear side) of the user's ear. For another example, the shell 110 is disposed over the user's ear without blocking or covering the user's ear canal. For another example, the shell 110 is partially disposed within the user's ear canal. In some embodiments, at least one sound outlet is included in the shell 110, and a sound generated by vibration of the diaphragm 120 is radiated in a direction to the user's ear through the sound outlet.

The diaphragm 120 is disposed within the cavity of the shell 110 and separates the cavity to form at least two sub-cavities (e.g., a first sub-cavity 211-1 and a second sub-cavity 211-2 as shown in FIG. 2A). The diaphragm 120 is driven by an electrical signal to vibrate relative to the shell 110 to generate sound. The at least two sub-cavities are disposed on each side of the vibration direction of the diaphragm 120.

In some embodiments, to facilitate the adjustment of a compliance of the diaphragm 120 and a Q value of the speaker 100, a material for preparing the diaphragm 120 is a polymeric non-metallic material, for example, a polyetheretherketone (poly (ether-ether-ether-ketone), PEEK), a polyimide (PI), a polyphenylene sulfide (polyphenylene sulfide (PPS), poly (ethylene imine) (PEI), a silica gel, etc. In this situation, the speaker 100 is prone to generate a diaphragm splitting vibration in a middle high frequency band to form one or more higher order modes, which in turn causes more peaks and valleys in the middle high frequency band of a frequency response of the speaker 100, and affects the performance of the speaker 100 in the middle high frequency band.

In some embodiments, to reduce the high order mode in the vibration of the diaphragm 120 so as to enhance the performance of the speaker 100 in the middle high frequency band, the diaphragm 120 is a rigid vibration component. Specifically, an elastic modulus of the material of the diaphragm 120 is greater than 2E6 Pa. Preferably, the elastic modulus of the material of the diaphragm 120 is greater than 4E6 Pa. For example, the elastic modulus of the material of the diaphragm 120 is 8E6 Pa. In some embodiments, the material of the diaphragm 120 includes a metallic material and a non-metallic material. The metallic material includes, but is not limited to, aluminum alloys, stainless steel, magnesium-lithium alloys, etc. The non-metallic material includes, but is not limited to, carbon fiber composites, plant fiber composites, etc. In some embodiments, the material of the diaphragm 120 is preferably the metallic material with a low density and a high stiffness to make an overall weight of the speaker 100 smaller and to enhance the wearing experience of the user.

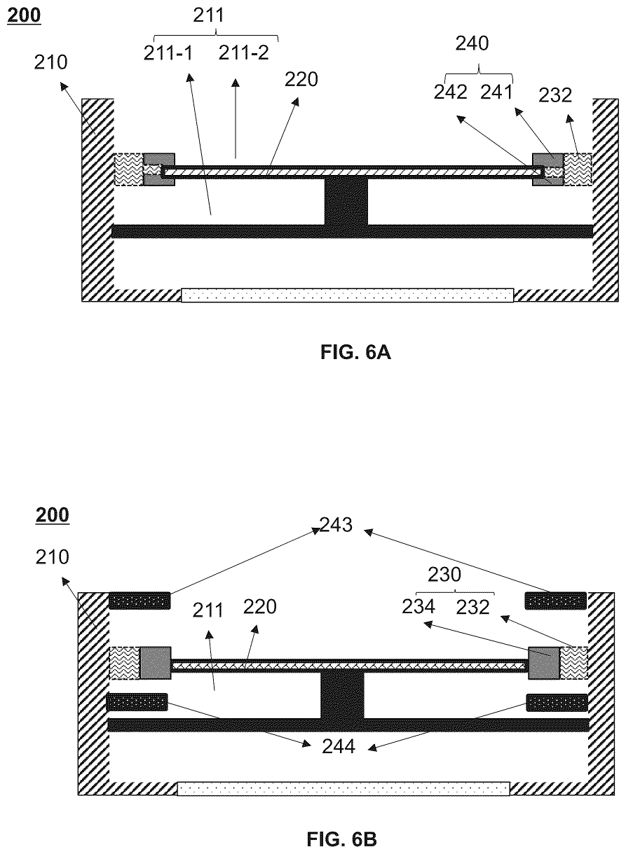

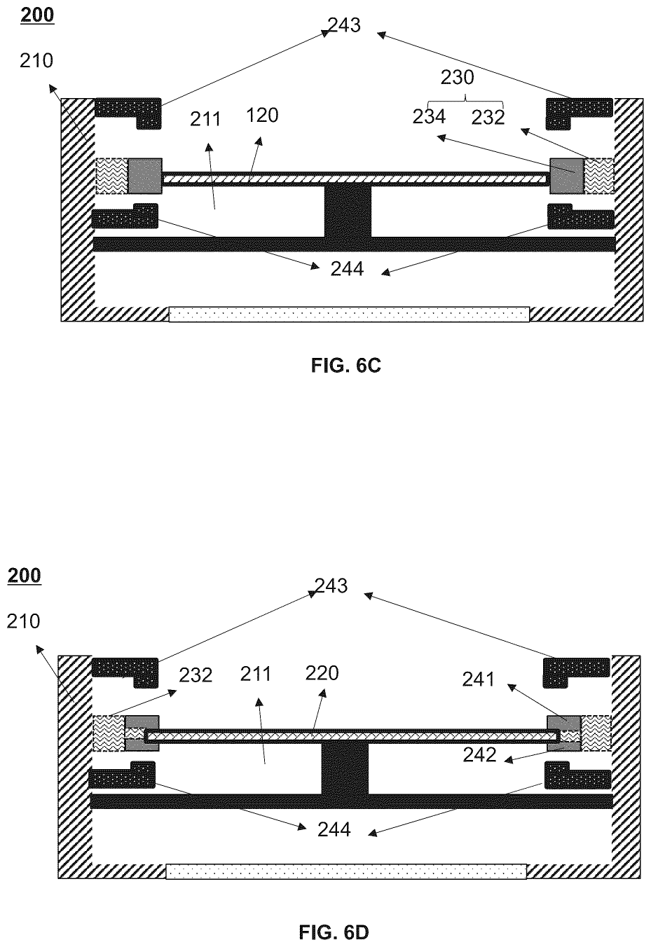

In some embodiments, to reduce a machining difficulty of the diaphragm 120, the diaphragm 120 is a flat plate structure. For example, the diaphragm 120 is a rigid vibration plate (such as the diaphragm 220 shown in FIG. 6A). When there is the sliding connection portion 130, the rigid vibration plate slides in the speaker 100 relative to the shell 110 such that the diaphragm 120 does not form the splitting vibration in an audible sound range of a human ear (e.g., 20 Hz-20 kHz), thereby flattening the frequency response curve output by the speaker 100 in the audible sound range of the human ear.

The sliding connection portion 130 is configured to connect an edge of the diaphragm 120 to an inner wall of the cavity. The sliding connection portion 130 is configured to allow the edge of the diaphragm 120 to slide relative to the inner wall of the shell 110, which in turn allows the diaphragm 120 as a whole to slide relative to the inner wall of the shell 110. In other words, the diaphragm 120 as a whole performs a piston-like movement relative to the shell 110. In some embodiments, the sliding connection portion 130 includes a magnetic fluid. At this point, the shell 110 includes a magnet. The diaphragm 120 drives the magnetic fluid to slide on a surface of the magnet. In some embodiments, the sliding connection portion 130 includes the magnetic fluid with the magnet. The diaphragm 120 is connected to the magnetic fluid through the magnet, which is in contact with the shell 110, and the diaphragm 120 drives the magnetic fluid through the magnet to slide on a surface of the inner wall of the shell 110. In some embodiments, the shell 110 includes a first magnet, and the sliding connection portion 130 includes a magnetic fluid and a second magnet. The diaphragm 120 is connected to the magnetic fluid through the second magnet. The diaphragm 120 drives, through the second magnet, the magnetic fluid to slide on a surface of the first magnet. In some embodiments, the sliding connection portion 130 includes a fluid (e.g., a viscous fluid), and the diaphragm 120 drives the fluid to slide on the surface of the inner wall of the shell 110. More descriptions of the sliding connection portion 130 may be found elsewhere in the present disclosure, for example, FIGS. 2A-2B, FIG. 4, FIGS. 5A-5D, FIGS. 7A-7B, FIGS. 8A-8B, etc., and their descriptions.

FIG. 2A is a schematic diagram illustrating a structure of an exemplary speaker according to some embodiments of the present disclosure. As shown in FIG. 2A, a speaker 200 is a piezoelectric speaker. The speaker 200 includes a shell 210, a diaphragm 220, and a sliding connection portion 230.

The shell 210 has a cavity 211. The diaphragm 220 is accommodated within the cavity 211 and separates the cavity 211 to form at least two sub-cavities (e.g., a first sub-cavity 211-1 and a second sub-cavity 211-2). The at least two sub-cavities (e.g., the first sub-cavity 211-1 and the second sub-cavity 211-2) are disposed on each side of a vibration direction of the diaphragm 220. The second sub-cavity 211-2 is communicated with a sound outlet (not shown in the figure) of the shell 210, and the first sub-cavity 211-1 is located on a side of the diaphragm 220 away from the sound outlet. In some embodiments, the first sub-cavity 211-1 is referred to as a rear cavity and the second sub-cavity 211-2 is referred to as a front cavity. The diaphragm 220 is driven by an electrical signal to vibrate relative to the shell 210 to generate sound.

The sliding connection portion 230 is configured to connect an edge of the diaphragm 220 to an inner wall of the cavity. The sliding connection portion 230 is configured to allow the edge of the diaphragm 220 to slide relative to the inner wall of the shell 210, which in turn allows the diaphragm 120 as a whole to slide relative to the inner wall of the shell 110. Thus, relative to a speaker where the edge of the diaphragm does not slide relative to the inner wall of the shell, the diaphragm 220 of the speaker 200 is displaced as a whole relative to the shell 210, which generates a greater displacement (e.g., a position of the diaphragm 220 in the dashed line in FIG. 2A relative to the position of the diaphragm 220 in the solid line), thereby increasing a volume of the air pushed by the diaphragm 220, and thereby enhancing the performance of the speaker 200.

In some embodiments, the sliding connection portion 230 is a magnetic fluid 232, as shown in FIG. 2A. In some embodiments, the magnetic fluid 232 includes a liquid (e.g., a colloidal liquid) made of magnetic particles (e.g., nanoscale ferromagnetic or subferromagnetic particles, iron nitride particles, etc.) suspended in a carrier liquid. The magnetic fluid 232 responds to an external magnetic field (e.g., a magnetic field of the first magnet 212 as described later), i.e., the magnetic fluid 232 is attracted to a nearby magnet (e.g., the first magnet 212 as described later, etc.). In some embodiments, the carrier liquid of the magnetic fluid 232 is an aqueous liquid or an oily liquid. For example, the carrier liquid of the magnetic fluid 232 is water, kerosene, motor oil, polyphenylene ether, silicone oil, etc., or any combination thereof.

When the sliding connection portion 230 is the magnetic fluid 232, the shell 210 includes the first magnet 212. The first magnet 212 is disposed in a region on the inner wall of the shell 210 corresponding to the position of the diaphragm 220. In some embodiments, the region on the inner wall of the shell 210 corresponding to the position of the diaphragm 220 refers to a region on the inner wall of the shell 210 covered by a vibration amplitude of the diaphragm 220, i.e., a sliding range of the magnetic fluid 232. In some embodiments, the sliding range of the magnetic fluid 232 is in a range of Omm-5 mm. A surface of the first magnet 212 forms at least a portion of the inner wall of the cavity of the shell 210. In some embodiments, a size of the first magnet 212 is greater than the vibration amplitude of the diaphragm 220 along the vibration direction of the diaphragm 220. In other words, the vibration amplitude of the diaphragm 220 (or a movement range of the magnetic fluid 232) does not exceed a size range of the first magnet 212. In some embodiments, the first magnet 212 includes a permanent magnet or a flexible magnet. For example, the first magnet 212 is a magnet.

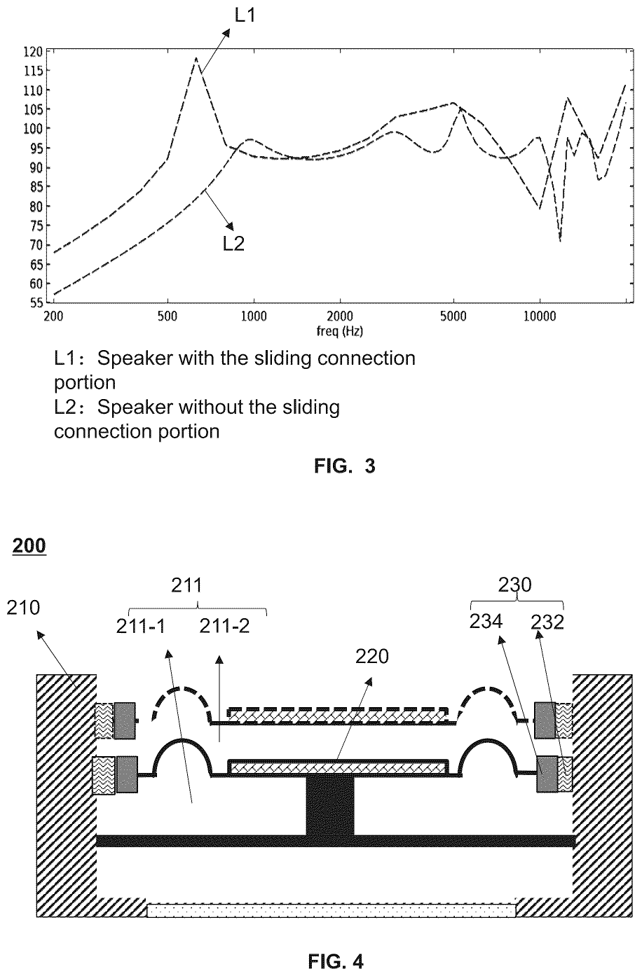

The edge of the diaphragm 220 is connected to the magnetic fluid 232. The magnetic fluid 232 is disposed between the edge of the diaphragm 220 and the first magnet 212. The diaphragm 220 drives the magnetic fluid 232 (i.e., the sliding connection portion 230) to slide on the surface of the first magnet 212. During a vibration process of the diaphragm 220 (or a sliding process of the diaphragm 220 relative to the shell 210), due to the existence of a magnetic attraction between the first magnet 212 and the magnetic fluid 232, the first magnet 212 makes the magnetic fluid 232 to remain in contact with the first magnet 212 at all times during the vibration process of the diaphragm 220, so as to ensure that the first sub-cavity 211-1 and the second sub-cavity 211-2 do not conduct. At the same time, as the first magnet 212 has less constraint on the diaphragm 220, the diaphragm 220 is allowed to achieve a piston movement, which in turn enhances output of the speaker 200, especially the output at low frequencies (as shown in FIG. 3). In some embodiments, by changing the carrier liquid of the magnetic fluid 232, the Q value of the speaker 200 is adjusted to further enhance the performance of the speaker 200. For example, by increasing the viscosity of the carrier liquid of the magnetic fluid 232, the damping of the magnetic fluid 232 is increased, which decreases the Q value of the speaker 200. Correspondingly, by decreasing the viscosity of the carrier liquid of the magnetic fluid 232, the damping of the magnetic fluid 232 is decreased, and thus the Q value of the speaker 200 is increased. For another example, by reducing a width of a gap where the magnetic fluid 232 is located (i.e., a distance between the diaphragm 220 and the inner wall of the shell 210), the Q value of the speaker 200 is reduced. Correspondingly, by increasing the width of the gap where the magnetic fluid 232 is located, the Q value of the speaker 200 is increased.

In some embodiments, the edge of the diaphragm 220 is disposed with a magnetic fluid fixing member (not shown) for connecting the magnetic fluid 232 to the diaphragm 220. The magnetic fluid fixing member has a relatively large contact surface with the magnetic fluid 232, so that the magnetic fluid 232 is stably constrained within the magnetic fluid fixing member. For example, the magnetic fluid fixing member has a “concave” structure, and the magnetic fluid 232 is placed within the “concave” structure.

In some embodiments, to enable the magnetic fluid 232 to be stably disposed between the edge of the diaphragm 220 and the first magnet 212, a distance between the edge of the diaphragm 220 and the first magnet 212 is in a range of 20 μm-2 mm.

In some embodiments, the hydrophilic or lipophilic property of a surface material of the magnetic fluid fixing member consists with the carrier liquid property (also be referred to as the property of the carrier liquid) of the magnetic fluid 232, so as to enhance an intermolecular force (e.g., Van der Waals force) between the surface material of the magnetic fluid fixing member and the carrier liquid of the magnetic fluid 232, allowing the magnetic fluid fixing member to better constrain the magnetic fluid 232. In the embodiments of the present disclosure, the hydrophilic or lipophilic property of the material consisting the carrier liquid property of the magnetic fluid 232 refers to that if the carrier liquid property of the magnetic fluid 232 is an aqueous liquid, the material is a hydrophilic material, and on the contrary, if the carrier liquid property of the magnetic fluid 232 is an oily liquid, the material is lipophilic material.

It should be noted that in the present disclosure, the magnetic fluid 232 adopts any regular or irregular shape (e.g., the magnetic fluid 232 is wrapped by a film with a surface contour). In some embodiments, a specific amount of magnetic fluid 232 is determined according to actual situations. For example, the magnetic fluid 232 is dispersed between the first magnet 212 and the edge of the diaphragm 220 in a controlled manner to limit the amount of magnetic fluid 232.

In some embodiments, the speaker 200 further includes a piezoelectric element 261 and a vibration transfer unit 262. The piezoelectric element 261 is fixed to an inner wall of the first sub-cavity 211-1 of the shell 210 and connected to the diaphragm 220 through the vibration transfer unit 262. The piezoelectric element 261 powers the vibration of the diaphragm 220. The vibration transfer unit 262 transfers the vibration generated by the piezoelectric element 261 to the diaphragm 220, thereby making the diaphragm 220 to vibrate to generate sound.

In some embodiments, the shell 210 is further disposed with a second opening (not shown in the figures) connected to the first sub-cavity 211-1. The second opening allows the air to move freely in and out of the first sub-cavity 211-1 to enable changes in an air pressure in the second sub-cavity 211-2 to be as free from stagnation by the first sub-cavity 211-1 as possible, and thereby improving a sound quality of the sound output to the ear via the sound outlet. In some embodiments, the second opening is disposed with a dustproof/damping mesh 263 to increase the waterproof and dustproof performance of the speaker 200 and adjust a frequency response curve of the speaker 200.

FIG. 2B is a schematic diagram illustrating a structure of an exemplary speaker according to some other embodiments of the present disclosure. As shown in FIG. 2B, the speaker 200 is an electromagnetic speaker.

The electromagnetic speaker shown in FIG. 2B and the piezoelectric speaker shown in FIG. 2A have the same or similar structure except for a driving system. For example, the electromagnetic speaker shown in FIG. 2B has the shell 210, the diaphragm 220, and the sliding connection portion 230. The shell 210 has the cavity 211. The diaphragm 220 is accommodated within the cavity 211 and separates the cavity 211 to form at least two sub-cavities (e.g., the first sub-cavity 211-1 and the second sub-cavity 211-2). The diaphragm 220 is driven by an electrical signal and vibrates relative to the shell 210 to generate sound. For another example, the shell 210 includes the first magnet 212, and the sliding connection portion 230 is the magnetic fluid 232. The magnetic fluid 232 connects an edge of the diaphragm 220 to an inner wall of the cavity and allows the edge of the diaphragm 220 to slide relative to the inner wall of the shell 210, thereby allowing the diaphragm 220 to generate a greater displacement (e.g., a position of the diaphragm 220 shown by the dashed line in FIG. 2B relative to the position of the diaphragm 220 shown by the solid line), and increasing an amount of air pushed by the diaphragm 220, so as to enhance the performance of the speaker 200.

In some embodiments, the speaker 200 (the electromagnetic speaker) also includes a magnetic element 264, a magnetic conductive element 265, and a sound coil 266. The magnetic element 264, the magnetic conductive element 265, and the sound coil 266 are all disposed within the first sub-cavity 211-1. The magnetic element 264 is configured to provide a magnetic field. A magnetic gap is formed between the magnetic element 264 and the magnetic conductive element 265. The sound coil 266 is disposed on the diaphragm 220 and located in the magnetic gap. The sound coil 266 is connected to the diaphragm 220. When a current passes through the sound coil 266, the sound coil 266 is located within the magnetic field formed by the magnetic element 264 and the magnetic conductive element 265, and is subjected to an action of an amperometric force. The amperometric force drives the sound coil 266 to vibrate, and the vibration of the sound coil 266 drives the diaphragm 220 to vibrate, thereby generating sound.

For ease of description, the present disclosure uses a piezoelectric speaker as an example to describe the speaker 200.

FIG. 3 is a schematic diagram illustrating frequency response curves of a speaker with a sliding connection portion and a speaker without the sliding connection portion according to some embodiments of the present disclosure. As shown in FIG. 3, curve L1 represents a frequency response curve of a speaker (e.g., the speaker 200) with the sliding connection portion. Curve L2 represents a frequency response curve of a speaker without the sliding connection portion.

As can be seen in FIG. 3, in a low and middle frequency range (e.g., 200 Hz-5000 Hz), the speaker with the sliding connection portion (corresponding to curve L1) has a stronger output than the speaker without the sliding connection portion (corresponding to curve L2), and the provision of the sliding connection portion improves the output in the low frequency range (e.g., 200 Hz-1000 Hz) more significantly (e.g., by 20 dB-40 dB for the low frequency range) than the middle frequency range. As can be seen, by disposing the sliding connection portion, the output performance of the speaker 200 in the low and middle frequency range, especially the low frequency range, is improved. As a result, the diaphragm 220 generates a greater displacement under the same driving force, thereby increasing the amount of air pushed by the diaphragm 220, and improving the performance of the speaker 200.

FIG. 4 is a schematic diagram illustrating a structure of an exemplary speaker according to some embodiments of the present disclosure. As shown in FIG. 4, in some embodiments, the sliding connection portion 230 includes the magnetic fluid 232 and a second magnet 234. The first magnet 212 is not provided on the shell 210. An inner wall of the cavity 211 is a smooth surface.

An edge of the diaphragm 220 is connected to the second magnet 234. The second magnet 234 is connected to the inner wall of the shell 210 through the magnetic fluid 232. The magnetic fluid 232 slides with the second magnet 234 relative to the inner wall of the shell 210 through a magnetic force between the magnetic fluid 232 and the second magnet 234, so that the diaphragm 220 generates a greater displacement (e.g., a position of the diaphragm 220 shown by the dashed line relative to the position of the diaphragm 220 shown by the solid line in FIG. 4), thereby increasing an amount of air pushed by the diaphragm 220, and improving the performance of the speaker 200. Specifically, during the vibration of the diaphragm 220, the diaphragm 220 drives the second magnet 234 to move. As there is a magnetic attraction between the second magnet 234 and the magnetic fluid 232, the second magnet 234 drives the magnetic fluid 232 to move with the second magnet 234, so that the magnetic fluid 232 remains in contact with the inner wall of the cavity 211, thereby ensuring that the first sub-cavity 211-1 does not conduct with the second sub-cavity 211-2. At the same time, as the inner wall of the cavity 211 has less constraint on the magnetic fluid 232, the diaphragm 220 is able to perform a piston movement, which in turn improves the output of the speaker 200. Furthermore, by changing a carrier liquid of the magnetic fluid 232, a Q value of the speaker 200 is adjusted, thereby further improving the performance of the speaker 200.

In some embodiments, to enable the magnetic fluid 232 to be stably disposed between the inner wall of the cavity 211 and the second magnet 234, a distance between the inner wall of the cavity 211 and the second magnet 234 is in a range of 20 μm-2 mm. In some embodiments, to make the magnetic fluid 232 more stably disposed between the inner wall of the cavity 211 and the second magnet 234, a surface material of the inner wall of the cavity 211 or the carrier liquid of the magnetic fluid 232 is changed, so as to make the carrier liquid property to be consistent with the hydrophilic or lipophilic property of the surface material of the inner wall of the cavity 211. For example, when the carrier liquid of the magnetic fluid 232 is an aqueous liquid, the surface material of the inner wall of the cavity 211 is a hydrophilic material. When the carrier liquid of the magnetic fluid 232 is an oily liquid, the surface material of the inner wall of the cavity 211 is an oleophilic material. In this way, during the movement of the magnetic fluid 232 along with the second magnet 234, the magnetic fluid 232 is always adhered to the inner wall of the cavity 211, so as to maintain the sealing between the edge of the diaphragm 220 and the inner wall of the shell 210.

In some embodiments, when the speaker 200 is subjected to a greater external impact force (e.g., when dropped from a high elevation), and to allow the magnetic fluid 232 quickly returns between the inner wall of the cavity 211 and the second magnet 234, the carrier liquid of the magnetic fluid 232 or the surface material of the inner wall of the cavity 211 is changed, so that the carrier liquid property is consistent with the hydrophilic or lipophilic property of the surface material of the inner wall of the cavity 211 within a sliding range of the magnetic fluid 232, and the carrier liquid property is inconsistent with the hydrophilic or lipophilic property of the surface material of the inner wall of the cavity 211 outside the sliding range of the magnetic fluid 232. Specifically, the carrier liquid of the magnetic fluid 232 is an aqueous liquid or an oily liquid. The material of the inner wall of the cavity 211 within the sliding range of the magnetic fluid 232 is a first surface material. The material of the inner wall of the cavity 211 outside the sliding range of the magnetic fluid 232 is a second surface material. In some embodiments, the carrier liquid property of the magnetic fluid 232 is the same as the hydrophilic or lipophilic property of the first surface material, and the hydrophilic or lipophilic property of the first surface material is opposite to the hydrophilic or lipophilic property of the second surface material. In some embodiments, when the hydrophilic or lipophilic property of the first surface material is opposite to the hydrophilic or lipophilic property of the second surface material, the greater a difference between a hydrophilic-lipophilic balance value of the first surface material and a hydrophilic-lipophilic balance value of the second surface material, the smaller the adhesion of the second surface material to the magnetic fluid 232, so as to make it easier for splashed magnetic fluid 232 to return to a vicinity of the second magnet 234. The difference between the hydrophilic-lipophilic balance value of the first surface material and the hydrophilic-lipophilic balance value of the second surface material is in a range of 2-40. Preferably, the difference between the hydrophilic-lipophilic balance value of the first surface material and the hydrophilic-lipophilic balance value of the second surface material is in a range of 5-40. More preferably, the difference between the hydrophilic-lipophilic balance value of the first surface material and the hydrophilic-lipophilic balance value of the second surface material is in a range of 9-40.

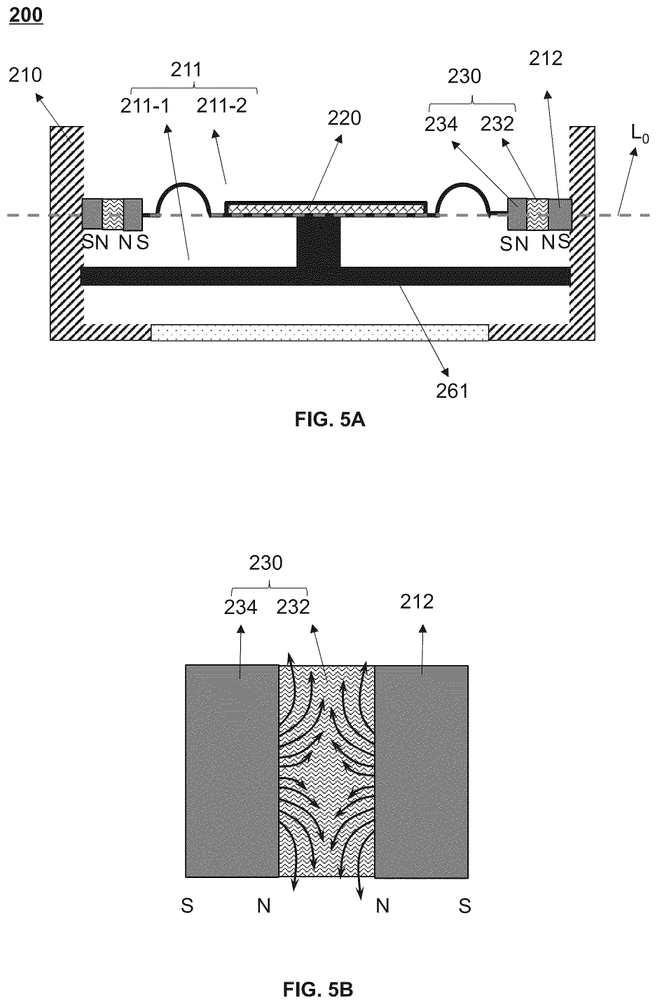

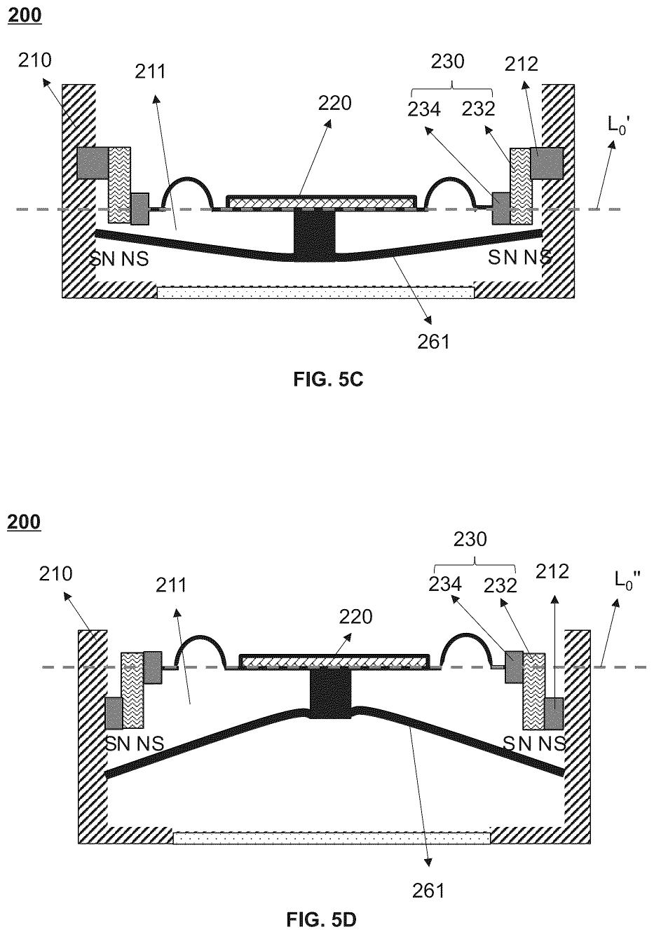

FIG. 5A is a schematic diagram illustrating a structure of an exemplary speaker according to some embodiments of the present disclosure. FIG. 5B is a schematic illustrating a local distribution of magnetic induction lines of a magnet in FIG. 5A. FIG. 5C is a schematic diagram illustrating the speaker shown in FIG. 5A when the diaphragm is in a position with a first maximum vibration amplitude. FIG. 5D is a schematic diagram illustrating the speaker shown in FIG. 5A when the diaphragm is in a position with a second maximum vibration amplitude.

As shown in FIG. 5A, in some embodiments, the shell 210 includes the first magnet 212, and the sliding connection portion 230 includes the magnetic fluid 232 and the second magnet 234. The magnetic fluid 232 is disposed between two magnet structures through magnetic attraction of the first magnet 212 with the second magnet 234. Specifically, a surface of the first magnet 212 forms at least a portion of an inner wall of the cavity 211. The edge of the diaphragm 220 is connected to the second magnet 234. The second magnet 234 is connected to the first magnet 212 through the magnetic fluid 232. As the first magnet 212 is fixedly disposed on the inner wall of the shell 210, when the diaphragm 220 is vibrating, the diaphragm 220 drives the second magnet 234 to move, which in turn pulls the magnetic fluid 232 to slide on the surface of the first magnet 212. As the magnetic fluid 232 always remains connected to the first magnet 212 and the second magnet 234, during a vibration process of the diaphragm 220, the magnetic fluid 232 ensures nonconductivity between the first sub-cavity 211-1 and the second sub-cavity 211-2. Meanwhile, as the first magnet 212 has a smaller constraint on the diaphragm 220, the diaphragm 220 performs a piston movement, which in turn improves the output of the speaker 200. In some embodiments, by changing the carrier liquid of the magnetic fluid 232, the Q value of the speaker 200 is adjusted, thereby further improving the performance of the speaker 200.

In some embodiments, as shown in FIG. 5A and FIG. 5B, the first magnet 212 and the second magnet 234 are arranged with the same magnetic poles facing each other. For example, an S magnetic pole of the first magnet 212 and an S magnetic pole of the second magnet 234 faces each other (i.e., the S magnetic poles of the first magnet 212 and the second magnet 234 are disposed adjacent to each other); or, an N magnetic pole of the first magnet 212 and an N magnetic pole of the second magnet 234 faces each other (i.e., the N magnetic poles of the first magnet 212 and the second magnet 234 are disposed adjacent to each other). By arranging the same magnetic poles of the first magnet 212 and the second magnet 234 face to each other, the first magnet 212 and the second magnet 234 are made to repel each other, thereby making a state when the first magnet 212 and the second magnet 234 face to each other (as shown in FIG. 5A, the diaphragm 220 is located at a position of an initial structural balance line L0) is a non-balance state. In the vibration direction of the diaphragm 220, when the diaphragm 220 reaches downwardly to a position of a first maximum vibration amplitude, the diaphragm 220 is in a first balance state (e.g., as shown in FIG. 5C, a position where the diaphragm 220 is located at a first magnetic balance line L0′); when the diaphragm 220 reaches upwardly to a position of a second maximum vibration amplitude, the diaphragm 220 is in a second balance state (e.g., as shown in FIG. 5D, a position where the diaphragm 220 is located at a second magnetic balance line L0″).

When the driver unit (e.g., the piezoelectric element 261) of the speaker 200 provides a driving force, two magnets (i.e., the first magnet 212 and the second magnet 234) switch between the first balance state and the second balance state, which results in a greater displacement of the diaphragm 220 relative to the first magnet 212 (the shell 210), and a better output performance of the speaker 200. In addition, in a process of switching, due to the presence of a magnet repelling force, the speaker 200 reaches another balance state quickly under an action of the magnetic force with a very small driving force after passing the position of the initial structural balance line L0, and thus improve a diaphragm travel of the speaker 200 and a vibration speed of the diaphragm 220, thereby improving the output performance of the speaker 200.

In some embodiments, along the vibration direction of the diaphragm 220, a height of the first magnet 212 is set relatively small, e.g., the height of the first magnet 212 is the same as a height of the second magnet 234 and a height of the magnetic fluid 232, as shown in FIG. 5A and FIG. 5B. At this time, the first magnet 212 is set at a position on the shell 210 corresponding to the initial structural balance line L0 (i.e., an initial position of the diaphragm 220). In some embodiments, the height of the first magnet 212 is smaller than the vibration amplitude of the diaphragm 220. Thus, in a vibration process of the diaphragm 220, as the position of the first magnet 212 is fixed relative to the shell 210, when the diaphragm 220, the second magnet 234, and the magnetic fluid 232 move, there is a situation where the magnetic fluid 232 moves outside a range of the corresponding region of the surface of the first magnet 212. However, as there is a certain fluidity in the magnetic fluid 232, the magnetic fluid 232 is extended, and a portion of the magnetic fluid 232 is still located within the corresponding region of the surface of the first magnet 212, and the other portion of the magnetic fluid 232 is extended to extend outside the range of the region corresponding to the surface of the first magnet 212, as shown in FIG. 5C, and FIG. 5D. When the diaphragm 220 is moved to within the corresponding region of the surface of the first magnet 212, the magnetic fluid 232 is subjected to the magnetic force of the second magnet 234 and the first magnet 212, and the extended portion of the magnetic fluid 232 is retracted to the range of the corresponding region of the surface of the first magnet 212.

In some embodiments, the height of the first magnet 212 is set relatively great along the vibration direction of the diaphragm 220, e.g., the height of the first magnet 212 is set to match the vibration amplitude of the diaphragm 220. At this time, a position relationship between the first magnet 212 and the magnetic fluid 232 is similar to the relationship shown in FIG. 2A. When the diaphragm 220 is vibrating, the second magnet 234 follows the diaphragm 220 to move and drives the magnetic fluid 232 to slide on the surface of the first magnet 212.

In some embodiments, during an operation process of the speaker 200, the magnetic fluid 232 (e.g., as the magnetic fluid 232 in the speaker 200 shown in FIG. 2A, FIG. 4, and FIG. 5A) vibrates up and down with the vibration of the diaphragm 220. When the speaker 200 is subjected to a great external impact (e.g., when dropped from a high place), the magnetic attraction of the magnet (e.g., the first magnet 212 and/or the second magnet 234) on the magnetic fluid 232 is not sufficient to fully constrain the magnetic fluid 232, resulting in the magnetic fluid 232 to splash. On the one hand, the splash of the magnetic fluid 232 causes a total amount of the magnetic fluid 232 to become less and less, which ultimately affects the stable output of the speaker 200, on the other hand, the splash of the magnetic fluid 232 causes an interference for other components of the speaker 200. To avoid the splash of the magnetic fluid 232, in some embodiments, the speaker 200 further includes a magnetic fluid constraint structure. The magnetic fluid constraint structure constrains the magnetic fluid 232, and limits a position range of the magnetic fluid 232, thereby better avoiding the splash of the magnetic fluid 232.

FIG. 6A is a schematic diagram illustrating a structure of an exemplary speaker according to some embodiments of the present disclosure. As shown in FIG. 6A, in some embodiments, the speaker 200 also includes a magnetic fluid constraint structure 240. The magnetic fluid constraint structure 240 includes at least one magnetic fluid constraint element to constrain a position range of the magnetic fluid 232 in a certain direction, thereby better avoiding the splash of the magnetic fluid 232 in the direction. For example, the magnetic fluid constraint structure 240 includes a first magnetic fluid constraint element 241 and a second magnetic fluid constraint element 242, as shown in FIG. 6A. The first magnetic fluid constraint element 241 and the second magnetic fluid constraint element 242 are disposed on the diaphragm 220. At this time, the first magnetic fluid constraint element 241 and the second magnetic fluid constraint element 242 are magnets. The first magnetic fluid constraint element 241 and the second magnetic fluid constraint element 242 are respectively disposed on opposite sides of the magnetic fluid 232 along a vibration direction of the diaphragm 220. Specifically, the first magnetic fluid constraint element 241 and the second magnetic fluid constraint element 242 are disposed on upper and lower sides of the edge of the diaphragm 220, respectively, so as to constrain a movement range of the magnetic fluid 232 along the vibration direction of the diaphragm 220.

In some embodiments, when there is no second magnet 234 between the magnetic fluid 232 and the diaphragm 220 (as shown in FIG. 2A), the magnetic fluid constraint structure 240 is disposed at a position where the magnetic fluid 232 is connected to the diaphragm 220. At this time, the magnetic fluid constraint structure 240 is equivalent to the aforementioned magnetic fluid fixing member. At this time, the magnetic fluid constraint structure 240, on the one hand, constrains the magnetic fluid 232 to avoid the splashing at the position where the magnetic fluid 232 is connected to the diaphragm 220, and on the other hand, increases the connection strength of between the magnetic fluid 232 and the diaphragm 220. In some embodiments, the magnetic fluid constraint structure 240 (the first magnetic fluid constraint element 241 and/or the second magnetic fluid constraint element 242) includes a magnet, and the magnetic fluid 232 is further constrained through the magnetic attraction of the magnet on the magnetic fluid 232.

In some embodiments, when there is the second magnet 234 between the magnetic fluid 232 and the diaphragm 220 (as shown in FIG. 4 or FIG. 5A), the magnetic fluid constraint structure 240 is disposed on the second magnet 234.

In some embodiments, the first magnetic fluid constraint element 241 and the second magnetic fluid constraint element 242 are annular, so as to facilitate constraining all directions of the magnetic fluid 232, which is distributed in an annular shape between the diaphragm 220 and the inner wall of the shell 210.

FIG. 6B is a schematic diagram illustrating a structure of an exemplary speaker according to some other embodiments of the present disclosure. Referring to FIG. 6B, in some embodiments, the magnetic fluid constraint structure 240 also includes a third magnetic fluid constraint element 243 and a fourth magnetic fluid constraint element 244. The third magnetic fluid constraint element 243 and the fourth magnetic fluid constraint element 244 are disposed on the shell 210. Specifically, the third magnetic fluid constraint element 243 and the fourth magnetic fluid constraint element 244 are respectively disposed on the inner wall of the cavity 211 and are located outside the sliding range of the magnetic fluid 232. A distance between the third magnetic fluid constraint element 243 and an edge of the sliding range is within a first distance threshold range (e.g., 2 mm-5 mm), and a distance between the fourth magnetic fluid constraint element 244 and an edge of the sliding range is within a second distance threshold range (e.g., 2 mm-5 mm). The third magnetic fluid constraint element 243 and the fourth magnetic fluid constraint element 244 constrain the magnetic fluid 232, such that the magnetic fluid 232 moves at most to contact the third magnetic fluid constraint element 243 and/or the fourth magnetic fluid constraint element 244. Meanwhile, by disposing the third magnetic fluid constraint element 243 and the fourth magnetic fluid constraint element 244 within a threshold distance from the edge of the sliding range, on the one hand, it can avoid the magnetic fluid 232 from being too close to the third magnetic fluid constraint element 243 and the fourth magnetic fluid constraint element 244, which results in an interference on the sliding range of the magnetic fluid 232 by the third magnetic fluid constraint element 243 and the fourth magnetic fluid constraint element 244; on the other hand, it can also prevent the magnetic fluid 232 from being too far away from the third magnetic fluid constraint element 243 and the fourth magnetic fluid constraint element 244, which results in insufficient magnetic attraction of the magnet (e.g., the first magnet 212 or the second magnet 234) to the magnetic fluid splashed onto the third magnetic fluid constraint element 243 and/or the fourth magnetic fluid constraint element 244, causing the splashed magnetic fluid to return to the the magnet, thereby causing the third magnetic fluid constraint element 243 and the fourth magnetic fluid constraint element 244 to be ineffective in constraining the magnetic fluid 232.

In some embodiments, when the magnetic fluid constraint structure 240 is disposed on the diaphragm 220, as shown in FIG. 6A, the first magnetic fluid constraint element 241 and the second magnetic fluid constraint element 242 are disposed at the edge of the diaphragm 220, thereby constraining the magnetic fluid 232 near the first magnetic fluid constraint element 241 and the second magnetic fluid constraint element 242, i.e., between the edge of the diaphragm 220 and the inner wall of the shell 210, thereby allowing the magnetic fluid 232 to slide with the first magnetic fluid constraint element 241 and the second magnetic fluid constraint element 242 relative to the inner wall of the shell 210. To further improve the constraint effect of the magnetic fluid constraint structure 240 (i.e., the first magnetic fluid constraint element 241 and/or the second magnetic fluid constraint element 242) disposed at the edge of the diaphragm 220 on the magnetic fluid 232, a carrier liquid property of the magnetic fluid 232 is set to be the same as the hydrophilic or lipophilic property of the magnetic fluid constraint structure 240 (i.e., the first magnetic fluid constraint element 241 and/or the second magnetic fluid constraint element 242) to increase an adsorption force of the magnetic fluid constraint structure 240 on the magnetic fluid 232.

In some embodiments, when the magnetic fluid constraint structure 240 is disposed on the shell 210, as shown in FIG. 6B, the third magnetic fluid constraint element 243 and the fourth magnetic fluid constraint element 244 are disposed outside the sliding range of the magnetic fluid 232, making it impossible for the magnetic fluid 232 to approach or cross the third magnetic fluid constraint element 243 and the fourth magnetic fluid constraint element 244, thereby well limiting the magnetic fluid 232 within the sliding region. In some embodiments, to further improve the constraint effect of the magnetic fluid constraint structure 240 (i.e., the third magnetic fluid constraint element 243 and/or the fourth magnetic fluid constraint element 244) disposed on the shell on the magnetic fluid 232, the carrier liquid property of the magnetic fluid 232 is set to be opposite to the hydrophilic or lipophilic property of the magnetic fluid constraint structure 240 (i.e., the third magnetic fluid constraint element 243 and/or the or the fourth magnetic fluid constraint element 244), thereby making the magnetic fluid 232 to repel the third magnetic fluid constraint element 243 and/or the fourth magnetic fluid constraint element 244, and reducing an adsorption capacity of the magnetic fluid constraint structure 240 (i.e., the third magnetic fluid constraint element 243 and/or the fourth magnetic fluid constraint element 244) disposed on the shell 210 on the magnetic fluid 232. For example, when the carrier liquid of the magnetic fluid 232 is an oily liquid, the fourth surface material of the magnetic fluid constraint structure 240 (i.e., the third magnetic fluid constraint element 243 and the fourth magnetic fluid constraint element 244) disposed on the shell 210 is a hydrophilic material to reduce an adhesion force of the fourth surface material of the magnetic fluid constraint structure 240 (i.e., the third magnetic fluid constraint element 243 and the fourth magnetic fluid constraint element 244) disposed on the shell 210 to the magnetic fluid 232, making the magnetic fluid 232 to quickly return to the magnet by the magnetic attraction force of the magnet (e.g., the first magnet 212 and/or the second magnet 234) after the magnetic fluid 232 is splashed onto the magnetic fluid constraint structure 240 (i.e., the third magnetic fluid constraint element 243 and/or the fourth magnetic fluid constraint element 244) disposed on the shell 210. In some embodiments, when the magnetic fluid constraint structure 240 is disposed on the shell 210, the greater a difference between a hydrophilic-lipophilic balance value of the fourth surface material of the magnetic fluid constraint structure 240 and a hydrophilic-lipophilic balance value of the carrier liquid of the magnetic fluid 232, the smaller the adhesion force of the magnetic fluid constraint structure 240 disposed on the shell 210 to the magnetic fluid 232. In some embodiments, the difference between the hydrophilic-lipophilic balance value of the fourth surface material of the magnetic fluid constraint structure 240 disposed on the shell 210 and the hydrophilic-lipophilic balance value of the carrier liquid of the magnetic fluid 232 is in a range of 2-40. Preferably, the difference between the hydrophilic-lipophilic balance value of the fourth surface material of the magnetic fluid constraint structure 240 disposed on the shell 210 and the hydrophilic-lipophilic balance value of the carrier liquid of the magnetic fluid 232 is in a range of 5-40. More preferably, the difference between the hydrophilic-lipophilic balance value of the fourth surface material of the magnetic fluid constraint structure 240 disposed on the shell 210 and the hydrophilic-lipophilic balance value of the carrier liquid of the magnetic fluid 232 is in a range of 9-40.

FIG. 6C is a schematic diagram illustrating a structure of an exemplary speaker according to other embodiments of the present disclosure. Referring to FIG. 6C, in some embodiments, the magnetic fluid constraint structure 240 (i.e., the third magnetic fluid constraint element 243 and the fourth magnetic fluid constraint element 244) disposed on the shell 210 is a constraint structure with a folded edge. The folded edge faces the diaphragm 220. By disposing the folded edge, the magnetic fluid constraint structure 240 disposed on the shell 210 is able to further constrain the magnetic fluid 232 in an extension direction of the diaphragm 220. Exemplarily, with reference to FIG. 6C, in a vibration direction of the diaphragm 220, the folded edge of the third magnetic fluid constraint element 243 disposed above the diaphragm 220 faces downward, and the folded edge of the fourth magnetic fluid constraint element 244 disposed below the diaphragm 220 faces upward.

FIG. 6D is a schematic diagram illustrating a structure of an exemplary speaker according to some other embodiments of the present disclosure. Referring to FIG. 6D, in some embodiments, the magnetic fluid constraint structure 240 includes both the first magnetic fluid constraint element 241 and the second magnetic fluid constraint element 242 disposed on the diaphragm 220 and the third magnetic fluid constraint element 243 and the fourth magnetic fluid constraint element 244 disposed on the shell 210. The first magnetic fluid constraint element 241 and the second magnetic fluid constraint element 242 may be annular structures, and the first magnetic fluid constraint element 241 and the second magnetic fluid constraint element 242 are disposed at a connection position between the magnetic fluid 232 and the diaphragm 220. The third magnetic fluid constraint element 243 and the fourth magnetic fluid constraint element 244 are annular structures with folded edges, and the folded edges face the diaphragm 220. The third magnetic fluid constraint element 243 and the fourth magnetic fluid constraint element 244 are each disposed on the inner wall of the cavity 211 and are within a threshold distance from an edge of a sliding range of the magnetic fluid 232.

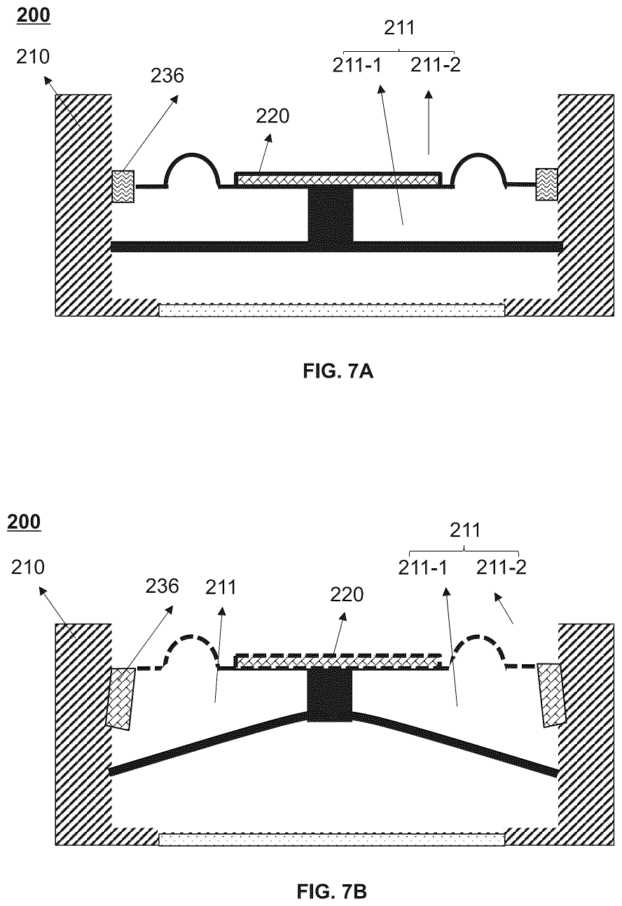

FIG. 7A is a schematic diagram illustrating a structure of an exemplary speaker according to some embodiments of the present disclosure. FIG. 7B is a schematic diagram illustrating the speaker shown in FIG. 7A when a diaphragm is vibrating. As previously mentioned, the movement of the magnetic fluid 232 is flexibly controlled and constrained within a certain range by designing the magnets (e.g., the first magnet 212 and/or the second magnet 234), so that the diaphragm 220 achieves a good piston movement. In addition, similar effects are achieved in other manners.

Referring to FIGS. 7A & 7B, in some embodiments, the speaker 200 does not include a magnet (e.g., the first magnet 212 and/or the second magnet 234), at which point the sliding connection portion 230 is a fluid 236. The diaphragm 220 is connected to the shell 210 through the fluid 236. During a vibration process of the diaphragm 220, the fluid 236 deforms to adapt to the vibration of the diaphragm 220 (as shown in FIG. 7B). As the fluid 236 remains connected to the inner wall of the shell 210 and the diaphragm 220, respectively, the fluid 236 keeps the first sub-cavity 211-1 and the second sub-cavity 211-2 from conducting. Meanwhile, as the inner wall of the cavity 211 is less constrained to the fluid 236, the diaphragm 220 achieves the piston movement, which in turn improves the output of the speaker 200. Further, by changing the property of the fluid 236, the Q value of the speaker 200 can be adjusted, thereby further enhancing the performance of the speaker 200.

In some embodiments, the fluid 236 is connected to the diaphragm 220 through a fluid fixing member (not shown), so that the diaphragm 220 drives the fluid 236 to deform. The fluid fixing member is similar to the magnetic fluid fixing member. For example, the fluid fixing member has a great contact surface with the fluid 236, such that the fluid 236 is stably constrained within the fluid fixing member. For example, the fluid fixing member has a “concave” structure, and the fluid 236 is constrained within the “concave” structure. For another example, the hydrophilic or lipophilic property of the surface material of the fluid fixing member is consistent with the hydrophilic or lipophilic property of the fluid 236 to improve the intermolecular force (e.g., Van der Waals force) between the surface material of the fluid fixing member and the fluid 236, so that the fluid fixing member can better constrain the fluid 236.

In some embodiments, to more stably dispose the fluid 236 on the inner wall of the cavity 211, the property of the fluid 236 or the surface material of the inner wall of the cavity 211 is changed to make the property of the fluid 236 consistent with the hydrophilic or lipophilic property of the surface material of the inner wall of the cavity 211. For example, the surface material of the inner wall of the cavity 211 is a hydrophilic material when the fluid 236 is water. When the fluid 236 is an oily liquid, the surface material of the inner wall of the cavity 211 is an oleophilic material.

In some embodiments, to avoid a fluid residue of the fluid 236 outside of a sliding range of the fluid 236, by changing the property of the fluid 236 or the surface material of the inner wall of the cavity 211, the property of the fluid 236 is consistent with the hydrophilic or lipophilic property of the surface material of the inner wall of the cavity 211 inside the sliding range of the fluid 236, and the property of the fluid 236 is opposite to the hydrophilic or lipophilic property of the surface material of the inner wall of the cavity 211 outside the sliding range of the fluid 236. Specifically, the fluid 236 may be an aqueous liquid or oily liquid. The material of the inner wall of the cavity 211 within the sliding range of the fluid 236 is a first surface material. The material of the inner wall of the cavity 211 outside the sliding range of the fluid 236 is a second surface material. The fluid 236 has the same hydrophilic or lipophilic property as the first surface material, and the hydrophilic or lipophilic properties of the first surface material and the second surface material are opposite.

In some embodiments, the fluid 236 is a viscous fluid. During the vibration process of the diaphragm 220, the diaphragm 220 is driven to deform the viscous fluid by a viscous force of the viscous fluid. In some embodiments, during the vibration process of the diaphragm 220, to avoid the fluid 236 from falling from the inner wall of the cavity 211 due to its gravity, and to maintain the viscous force between the fluid 236 and the diaphragm 220, a kinematic viscosity of the viscous fluid is greater than 100 cst. In some embodiments, the viscous fluid includes, but is not limited to, materials such as gels, sealants, oils, etc.

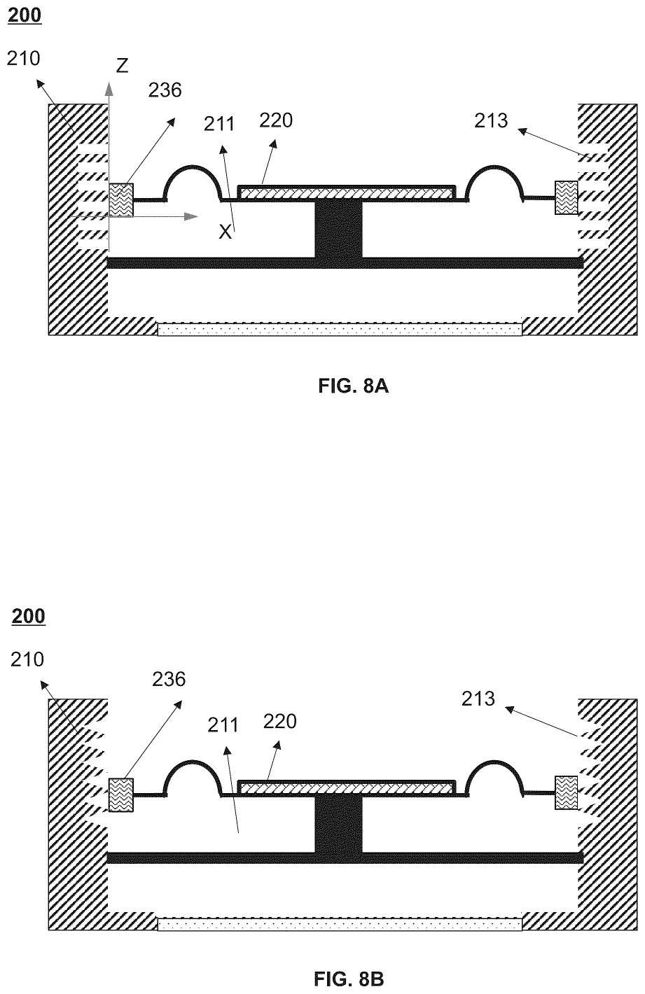

FIG. 8A is a schematic diagram illustrating a structure of an exemplary speaker according to some embodiments of the present disclosure. FIG. 8B is a schematic diagram illustrating a structure of an exemplary speaker according to some other embodiments of the present disclosure. Referring to FIGS. 8A and 8B, in some embodiments, to further increase an action force (e.g., a viscous force or an intermolecular force) between the fluid 236 (e.g., a viscous fluid) and the inner wall of the shell 210, and to better constrain the fluid 236 to ensure that the fluid 236 is still effectively adhered between the diaphragm 220 and the inner wall of the shell 210 under a relatively great impact, the inner wall of the cavity 211 is disposed with a concave or convex structure 213 in a region in contact with the fluid 236. The concave or convex structure 213 effectively improves an absorption force of the fluid 236 by the inner wall of the shell 210.

In some embodiments, the concave or convex structure 213 is arranged in a circumferential distribution of the cavity 211 on the inner wall of the shell 210. In some embodiments, the concave or convex structure 213 is disposed on the inner wall of the shell 210. In some embodiments, the concave or convex structure 213 protrudes from the inner wall of the shell 210.

In some embodiments, a shape of the concave or convex structure 213 includes, but is not limited to, a regular or irregular shape such as a columnar structure (as shown in FIG. 8A), a conical structure (as shown in FIG. 8B), etc.

Referring to FIG. 8A, in some embodiments, a size of the concave or convex structure 213 on the surface of the inner wall of the cavity 211 is in a range of 0.2 μm-200 μm along the vibration direction of the diaphragm 220 (e.g., such as direction Z in FIG. 8A), and is in a range of 0.2 μm-200 μm in a direction perpendicular to the inner wall of the cavity 211 (e.g., such as direction X in FIG. 8A). In some embodiments, each convex structure (e.g., a columnar structure) has a size in a range of 1 μm-100 μm along the vibration direction of the diaphragm 220, and a size in a range of 1 μm-100 μm along the direction perpendicular to the inner wall of the cavity 211. For example, each concave structure (e.g., the columnar structure) has a size of 2 μm along the vibration direction of the diaphragm 220 and a size of 5 μm along the direction perpendicular to the inner wall of the cavity 211.

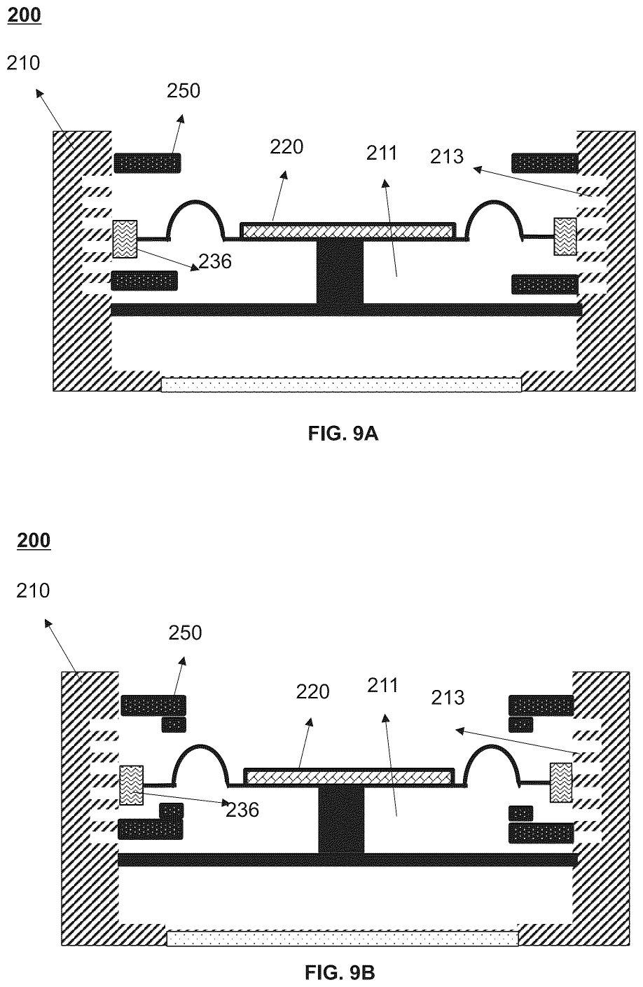

FIG. 9A is a schematic diagram illustrating a structure of an exemplary speaker according to some embodiments of the present disclosure. FIG. 9B is a schematic diagram illustrating a structure of an exemplary speaker according to some other embodiments of the present disclosure.

Referring to FIGS. 9A and 9B, in some embodiments, when the sliding connection portion 230 is the fluid 236 (e.g., a viscous fluid), the speaker 200 also includes a fluid constraint structure 250. The fluid constraint structure 250 further constrains the fluid 236, limiting a movement range of the fluid 236, thereby better avoiding a disengagement of the fluid 236 from the inner wall of the shell 210.

In some embodiments, the fluid constraint structure 250 includes an annular structure, as shown in FIG. 9A. In some embodiments, the annular structure of the fluid constraint structure 250 further includes a folded edge. The folded edge is disposed along a direction facing the diaphragm 220, as shown in FIG. 9B. In some embodiments, the relevant settings of the fluid 236 and the fluid constraint structure 250 are referred to the settings of the magnetic fluid 232 and the magnetic fluid constraint structure 240 in FIG. 6B, FIG. 6C, which are not repeated here.

Beneficial effects of the speaker provided by some embodiments of the present disclosure include, but are not limited to: (1) by disposing the sliding connection portion, the diaphragm as a whole slides relative to the shell, thereby increasing the volume of air pushed by the diaphragm, and improving the performance of the speaker; (2) by designing the magnetic fluid to cooperate with the first magnet and/or the second magnet, while ensuring that the first sub-cavity is not conduct to the second sub-cavity, a flexible control of the movement of the magnetic fluid is achieved, thereby enabling the diaphragm to realize a good piston movement; (3) by disposing the same magnetic poles of the first magnet and the second magnet face to each other, the moving displacement of the diaphragm is increased, thereby improving the travel and the vibration speed of the diaphragm, and improving the output performance of the speaker; (4) by disposing a corresponding constraint structure for the magnetic fluid or the fluid to constrain the magnetic fluid or the fluid, thereby better avoiding the magnetic fluid or the fluid from falling off; (5) by disposing the concave or convex structure, the fluid is further constrained, thereby avoiding the fluid from falling off. It should be noted that the beneficial effects generated by different embodiments are different, and the beneficial effects generated in different embodiments are any one or a combination of the foregoing, or any other beneficial effect that may be obtained.

The basic concepts have been described above, and it is apparent to those skilled in the art that the foregoing detailed disclosure serves only as an example and does not constitute a limitation of the present disclosure. While not expressly stated herein, various modifications, improvements, and amendments are made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

What is claimed is:

1. A speaker, comprising:
a shell including a cavity;
a diaphragm accommodated within the cavity, the diaphragm separating the cavity to form at least two sub-cavities, wherein the diaphragm is driven by an electrical signal to vibrate with respect to the shell to generate sound; and
a sliding connection portion configured to connect an edge of the diaphragm to an inner wall of the cavity, wherein the sliding connection portion allows the edge of the diaphragm to slide relative to an inner wall of the shell.

2. The speaker of claim 1, wherein the shell includes a magnet, the sliding connection portion is a magnetic fluid, a surface of the magnet forms at least a portion of the inner wall of the cavity, and the diaphragm drives the magnetic fluid to slide on the surface of the magnet.

3. The speaker of claim 1, wherein the sliding connection portion includes a magnet and a magnetic fluid, wherein
the magnet is connected to the diaphragm, and
the magnetic fluid is configured to connect the magnet to the inner wall of the cavity, wherein the magnetic fluid slides with the magnet relative to the inner wall of the shell by a magnetic force between the magnetic fluid and the magnet.

4. The speaker of claim 3, wherein
a carrier liquid of the magnetic fluid is an aqueous liquid or an oily liquid,
a material of the inner wall of the cavity within a sliding range of the magnetic fluid is a first surface material, and
a material of the inner wall of the cavity outside the sliding range of the magnetic fluid is a second surface material,
wherein a property of the carrier liquid is the same as a hydrophilic or lipophilic property of the first surface material, and the first surface material and the second surface material have opposite hydrophilic or lipophilic properties.

5. The speaker of claim 1, wherein the shell includes a first magnet, and the sliding connection portion includes a second magnet and a magnetic fluid, wherein
a surface of the first magnet forms at least a portion of the inner wall of the cavity,
the second magnet is connected to the diaphragm, and
the magnetic fluid is configured to connect the first magnet to the second magnet, and the diaphragm drives, through the second magnet, the magnetic fluid to slide on the surface of the first magnet.

6. The speaker of claim 5, wherein
the first magnet and the second magnet are arranged with the same magnetic poles facing each other.

7. The speaker of claim 2, wherein the speaker further includes:
a magnetic fluid constraint structure configured to constrain a position of the magnetic fluid.

8. The speaker of claim 7, wherein the magnetic fluid constraint structure includes a first magnetic fluid constraint element and a second magnetic fluid restraint element that are disposed on the diaphragm, the first magnetic fluid restraint element and the second magnetic fluid constraint element being provided to be located on opposite sides of the magnetic fluid along a vibration direction of the diaphragm, respectively.

9. The speaker of claim 8, wherein the magnetic fluid constraint structure is a magnet.

10. The speaker of claim 8, wherein a property of a carrier liquid of the magnetic fluid is the same as a hydrophilic or lipophilic property of a surface material of the magnetic fluid constraint structure.

11. The speaker of claim 7, wherein the magnetic fluid constraint structure includes a third magnetic fluid restraint element and a fourth magnetic fluid restraint element that are disposed on the inner wall of the cavity and located outside a sliding range of the magnetic fluid, wherein a distance between the third magnetic fluid constraint element and an edge of the sliding range is within a first distance threshold range, and a distance between the fourth magnetic fluid constraint element and the edge of the sliding range is within a second distance threshold range.

12. The speaker of claim 11, wherein a property of a carrier liquid of the magnetic fluid is opposite to a hydrophilic or oleophilic property of a surface material of the magnetic fluid constraint structure.

13. The speaker of claim 1, wherein the sliding connection portion is fluid, wherein
a material of the inner wall of the cavity within a sliding range of the fluid is a first surface material, and
a material of the inner wall of the cavity outside the sliding range of the fluid is a second surface material,
wherein hydrophilic or lipophilic properties of the fluid and the first surface material are the same, and hydrophilic or lipophilic properties of the fluid and the second surface material of a contact region between the diaphragm and the fluid are opposite.

14. The speaker of claim 13, wherein the fluid is a viscous fluid with a kinematic viscosity greater than 100 cst.

15. The speaker of claim 13, wherein a region on the inner wall of the cavity contacting the fluid is provided with a concave structure or a convex structure.

16. The speaker of claim 15, wherein
a size of the concave structure or the convex structure on a surface of the inner wall of the cavity along a vibration direction of the diaphragm is in a range of 0.2 μm-200 μm, and
a size of the concave structure or the convex structure along a direction perpendicular to the inner wall of the cavity is in a range of 0.2 μm-200 μm.

17. The speaker of claim 1, wherein the diaphragm is a rigid vibration plate.

18. The speaker of claim 1, wherein an elastic modulus of a material of the diaphragm is greater than 2×10⁶ Pa.

19. The speaker of claim 1, wherein an elastic modulus of a material of the diaphragm is greater than 4×10⁶ Pa.

20. The speaker of claim 2, wherein the edge of the diaphragm is disposed with a magnetic fluid fixing member for connecting the magnetic fluid to the diaphragm.
